(19) United States
(12) Patent Application Publication
(10) Pub. No.: US 2019/0062207 A1
(43) Pub. Date: Feb. 28, 2019

(54) METHOD OF REMOVING RESIDUE CONTAINING LITHIUM PHOSPHATE COMPOUNDS FROM A SURFACE CROSS-REFERENCE TO RELATED APPLICATIONS

(71) Applicant: Corning Incorporated, Corning, NY (US)

(72) Inventor: Yuhui Jin, Painted Post, NY (US)

(21) Appl. No.: 16/114,588

(22) Filed: Aug. 28, 2018

Related U.S. Application Data
(60) Provisional application No. 62/552,046, filed on Aug. 30, 2017.

(51) Int. Cl. C03C 23/00; C03C 21/00; C11D 11/00; C11D 7/08

(52) U.S. Cl. CPC C03C 23/0075; C03C 21/002; C03C 3/091; C11D 7/08; C11D 11/0023

(57) ABSTRACT

A method of removing residue containing an insoluble lithium phosphate compound from a surface includes soaking the surface in a cleaning aqueous solution having a pH less than 5 for a select time period, whereby the insoluble lithium phosphate compound is converted into soluble lithium hydrogen phosphate and the soluble lithium hydrogen phosphate is dissolved in the cleaning aqueous solution. The method includes rinsing the surface with deionized water. The surface is substantially free of the insoluble lithium phosphate compound after the rinsing.

### CROSS-REFERENCE TO RELATED APPLICATIONS

This application claims the benefit of priority under 35 U.S.C. § 119 of U.S. Provisional Application Ser. No. 62/552,046 filed on Aug. 30, 2017, the content of which is relied upon and incorporated herein by reference in its entirety.

### BACKGROUND

Strengthened glass materials are useful in applications where resistance to breakage and aesthetics are important, such as in cover glasses for consumer or handheld electronic devices. Lithium-containing glass materials are a class of glass materials that can be chemically strengthened by an ion-exchange process. The strengthening process works by substituting smaller-sized ions in the surface of the glass material with larger-sized ions, thereby placing the surface of the glass material in compression, which results in a glass material that is more resistant to breakage. In general, the higher the magnitude of the compressive stresses and the depth of the compressive stress layer (also known as depth of layer or “DOL” or depth of compression “DOC”) in the glass material, the higher the resistance of the glass material to breakage.

The ion-exchange process typically involves immersing the lithium-containing glass material in a salt bath containing alkali metal cations that are larger than lithium cations, where the salt bath is typically in molten form. The lithium cations will diffuse out of the glass material into the salt bath. The sites left in the glass material structure by the lithium cations will be occupied by the larger alkali metal cations from the salt bath. Lithium cations readily diffuse from glass materials compared to other alkali metal cations, which allows the ion-exchange process to occur at a faster rate compared to the ion exchange of other glass materials that do not contain lithium. The faster rate of ion exchange may allow a deeper compressive stress layer in the glass material to be achieved in a relatively short time.

One of the challenges of strengthening lithium-containing glass materials by ion exchange is the fast rate at which the salt bath ages or is poisoned. As the ion exchange proceeds, the salt bath concentration of the lithium cations will increase while the salt bath concentration of the larger alkali-metal cations will decrease. This will result in retardation of the ion exchange over time. After a few batches of glass materials have been ion exchanged in the salt bath, the salt bath will lose its effectiveness for strengthening by ion exchange. This means that the salt bath will have to be replaced relatively frequently, which would increase the manufacturing cost of strengthened lithium-containing glass materials and significantly reduce the process throughput

International Publication No. WO 2017/087742 (Corning Incorporated; Amin et al.) discloses methods for regenerating lithium-enriched salt baths. The methods involve adding a phosphate salt, or a mixture of phosphate salts, to the salt bath to precipitate the excess lithium cations in the salt bath to form solid lithium phosphate and other additional cations. Via precipitation of the excess lithium cations, the lithium cation concentration in the salt bath may be reduced to a level at which the salt bath is not considered to be poisoned or to a level at which the salt bath remains effective for strengthening by ion exchange. Some of the solid lithium phosphate will sink to the bottom of the ion-exchange tank. Some of the solid lithium phosphate will coat the surface of the glass material that is being treated in the salt bath.

After the ion-exchange process, the glass material surface may be covered with a salt crust containing solid lithium phosphate. Due to the very low solubility of lithium phosphate, this salt crust cannot be completely removed from the glass material by simply soaking and rinsing the glass material in water. In addition, there will be difficulties in cleaning the ion-exchange tank. Normally, when the molten salt bath needs to be removed from the ion-exchange tank, the majority of the molten salt bath is first vacuumed or drained from the tank. The residue on the surfaces of the tank is then usually dissolved in hot water and removed from the tank. However, when the residue contains solid lithium phosphate, it cannot be effectively removed by hot water. In this case, the residue has to be removed physically using drills or hammers. This removal method is slow and may damage the ion-exchange tank.

### SUMMARY

In some embodiments of the disclosure, a method of removing residue containing one or more insoluble lithium phosphate compounds from a surface includes soaking the surface in a cleaning aqueous solution having a pH less than 5 for a select time period, whereby at least one insoluble lithium phosphate compound in the residue is converted into soluble lithium hydrogen phosphate and the lithium hydrogen phosphate is dissolved in the cleaning aqueous solution. The method includes rinsing the surface with deionized water. After the rinsing, the subsurface is substantially free of the at least one insoluble lithium phosphate compound.

In other embodiments of the disclosure, a method of preparing strengthened glass or glass-ceramic includes heating a salt bath comprising a phosphate salt and at least one source of alkali metal cations to a temperature greater than 360° C. The method includes contacting at least a portion of an ion-exchangeable substrate comprising lithium cations with the salt bath, whereby at least a portion of the lithium cations diffuse from the ion-exchangeable substrate into the salt bath and are dissolved in the salt bath. The method includes selectively precipitating the dissolved lithium cations from the salt bath to form at least one lithium phosphate compound, wherein a portion of the at least one insoluble lithium phosphate compound is deposited on a surface of the ion-exchangeable substrate. The method includes soaking the surface of the ion-exchangeable substrate in a cleaning aqueous solution having a pH less than 5 for a select time period sufficient to convert the at least one insoluble lithium phosphate compound on the surface to soluble lithium hydrogen phosphate and dissolving the lithium hydrogen phosphate in the cleaning aqueous solution. The method includes rinsing the surface with deionized water. After the rinsing, the surface is substantially free of the at least one insoluble lithium phosphate compound.

According to a first aspect, a method of removing residue containing one or more insoluble lithium phosphate compounds from a surface is provided. The method comprises soaking the surface in a cleaning aqueous solution having a PH less than 5 for a selected time period, whereby at least one insoluble lithium phosphate compound in the residue is converted into soluble lithium hydrogen phosphate and the soluble lithium hydrogen phosphate is dissolved in the cleaning aqueous solution; and rinsing the surface with deionized water, wherein the surface is substantially free of the at least one insoluble lithium compound after the rinsing.

In a second aspect according to the first aspect, wherein the cleaning aqueous solution comprises an acid or acid mixture selected from nitric acid, hydrochloric acid, phosphoric acid, sulfuric acid, citric acid, acetic acid, tartaric acid, ascorbic acid, and mixtures thereof.

In a third aspect according to the first or second aspect, wherein the cleaning aqueous solution comprises an acid or acid mixture, and wherein the cleaning aqueous solution has an acid concentration in a range of 0.1 wt % to 10 wt %.

In a fourth aspect according to any one of the first through third aspects, wherein the surface is a surface of a lithium-containing glass material treated in a salt bath comprising a phosphate salt and at least one source of alkali metal cations larger than lithium cations.

In a fifth aspect according to any one of the first through fourth aspects, wherein the method further comprises maintaining the surface and the cleaning aqueous solution at a temperature from 20° C. to 100° C. during the soak.

In a sixth aspect according any one of the first through fifth aspects, wherein the select time period is in a range from 1 minute to 10 minutes.

In a seventh aspect according to any one of the first through third aspects, wherein the surface is a surface of an ion-exchange tank containing a salt bath during the treatment of a lithium-containing glass material in the salt bath, the salt bath comprising a phosphate salt and at least one source of alkali metal cations larger than lithium cations.

In an eighth aspect according to the seventh aspect, wherein the method further comprises maintaining a temperature of at least one of the surface and the cleaning aqueous solution at a temperature from 20° C. to 100° C. during at least a portion of the soaking.

In a ninth aspect according to the seventh aspect, wherein the method further comprises maintaining a temperature of at least one of the surface and the cleaning aqueous solution in a range from 40° C. to 100° C. during at least a portion of the soaking.

In a tenth aspect according to any one of the seventh through ninth aspects, wherein the select time period is greater than 1 hour.

In an eleventh aspect according to any one of the first through tenth aspects, wherein the at least one insoluble lithium phosphate compound is Li₃PO₄, Li₂NaPO₄, or LiNa₂PO₄.

In a twelfth aspect according to any one of the first through eleventh aspects, wherein the soluble lithium hydrogen phosphate comprises at least one of Li₂HPO₄ and LiH₂PO₄.

According to a thirteenth aspect, a method of preparing strengthened glass or glass-ceramic is provided. The method comprises: heating a salt bath comprising a phosphate salt and at least one source of alkali metal cations to a temperature greater than 360° C.; contacting at least a portion of an ion-exchangeable substrate comprising lithium cations with the salt bath, whereby at least a portion of the lithium cations diffuse from the ion-exchangeable substrate into the salt bath and are dissolved in the salt bath; selectively participating dissolved lithium cations from the salt bath to form at least one insoluble lithium phosphate compound, wherein a portion of the at least one insoluble lithium phosphate compound is deposited on a surface of the ion-exchangeable substrate; removing the ion-exchangeable substrate from the salt bath and soaking the surface in a cleaning aqueous solution having a pH less than 5 for a select time period, whereby the at least one insoluble lithium phosphate compound on the surface is converted into soluble lithium hydrogen phosphate and the soluble lithium hydrogen phosphate is dissolved in the cleaning aqueous solution; and rising the surface with deionized water, wherein the surface of the ion-exchanged substrate is substantially free of the at least one insoluble lithium phosphate compound after the rinsing.

In a fourteenth aspect according to the thirteenth aspect, wherein the cleaning aqueous solution comprises an acid or acid mixture selected from nitric acid, hydrochloric acid, phosphoric acid, sulfuric acid, citric acid, acetic acid, tartaric acid, ascorbic acid, and mixtures thereof.

In a fifteenth aspect according to the thirteenth or fourteenth aspect, wherein the cleaning aqueous solution comprises one or more acids, and wherein the cleaning aqueous solution has an acid concentration in a range of 0.1 wt % to 10 wt %.

In a sixteenth aspect according to any one of the thirteenth through fifteenth aspects, wherein the soaking occurs at a temperature from 20° C. to 100° C. and the select time period is less than 10 minutes.

In a seventeenth aspect according to any one of the thirteenth through sixteenth aspects, wherein the phosphate salt is added to the salt bath prior to contacting the at least a portion of the ion-exchangeable substrate with the salt bath.

In an eighteenth aspect according to any one of the thirteenth through seventeenth aspects, wherein the phosphate salt comprises at least one of Na₃PO₄, K₃PO₄, Na₂HPO₄, K₂HPO₄, Na₅P₃O₁₀, Na₂H₂P₂O₇, Na₄P₂O₇, K₄P₂O₇, Na₃P₃O₉, and K₃P₃O₉.

In a nineteenth aspect according to any one of the thirteenth through eighteenth aspects, wherein the at least one source of alkali metal cations comprises at least one of KNO₃ and NaNO₃.

In a twentieth aspect according to any one of the thirteenth through nineteenth aspects, wherein the ion-exchangeable substrate comprises an alkali aluminosilicate glass or an alkali aluminoborosilicate glass.

The foregoing general description and the following detailed description are exemplary of the invention and are intended to provide an overview or framework for understanding the nature of the invention as it is claimed. The accompanying drawings are included to provide further understanding of the invention and are incorporated in and constitute a part of this specification. The drawings illustrate various embodiments of the invention and together with the description serve to explain the principles and operation of the invention.

### BRIEF DESCRIPTION OF DRAWINGS

FIG. 1 shows ion-exchange process residue on a surface of a substrate.

FIG. 2 shows ion-exchange process residue on a surface of an ion-exchange tank.

FIG. 3A shows a glass piece with ion-exchange process residue.

FIG. 3B shows the glass piece of FIG. 3A after treatment with a cleaning aqueous solution.

FIG. 4A shows an ion-exchange tank 200 containing a salt bath and ion-exchangeable substrate.

FIG. 4B shows ion exchange between the salt bath and ion-exchangeable substrate of FIG. 4A.

### DETAILED DESCRIPTION

As used herein, the term “insoluble,” as applied to an ionic compound, refers to an ionic compound having a solubility less than 1 g per 100 g of water at room temperature (i.e., about 20° C.).

As used herein, the term “salt bath” refers to the solution or medium used to effect an ion-exchange process with an ion-exchangeable substrate.

As used herein, the term “ion-exchange tank” refers to a tank or container which holds a salt bath during an ion-exchange process.

As used herein, the term “lithium-containing glass material” refers to a glass or glass-ceramic substrate or article of any shape or form containing lithium.

As used herein, the term “ion-exchange residue” refers to residue left on a surface as a result of exposing the surface to a salt bath during an ion-exchange process.

During an ion-exchange process involving an ion-exchangeable substrate containing lithium and where a phosphate salt has been used to precipitate excess lithium cations in the salt bath, it has been found that the majority of the insoluble salts generated in the salt bath are insoluble lithium phosphate compounds, such as lithium phosphate (Li₃PO₄) and lithium sodium phosphate (NaLi₂PO₄). For illustrative purposes, an X-Ray Powder Diffraction (XRD) analysis of an example ion-exchange process residue on the surface of an ion-exchangeable substrate treated as described above revealed the presence of the following salts in the residue: lithiophosphate (Li₃PO₄), nalipoite (NaLi₂PO₄), Niter, NaH₅(PO₄)₂, and NaNO₃. Out of these salts, only lithiophosphate and nalipoite are insoluble in water. These insoluble lithium phosphate compounds are difficult to remove from surfaces by soaking and rinsing the surfaces in water. Embodiments described herein are directed to methods for removing residues containing insoluble lithium phosphate compounds from surfaces, such as surfaces of ion-exchangeable substrates and ion-exchange tanks.

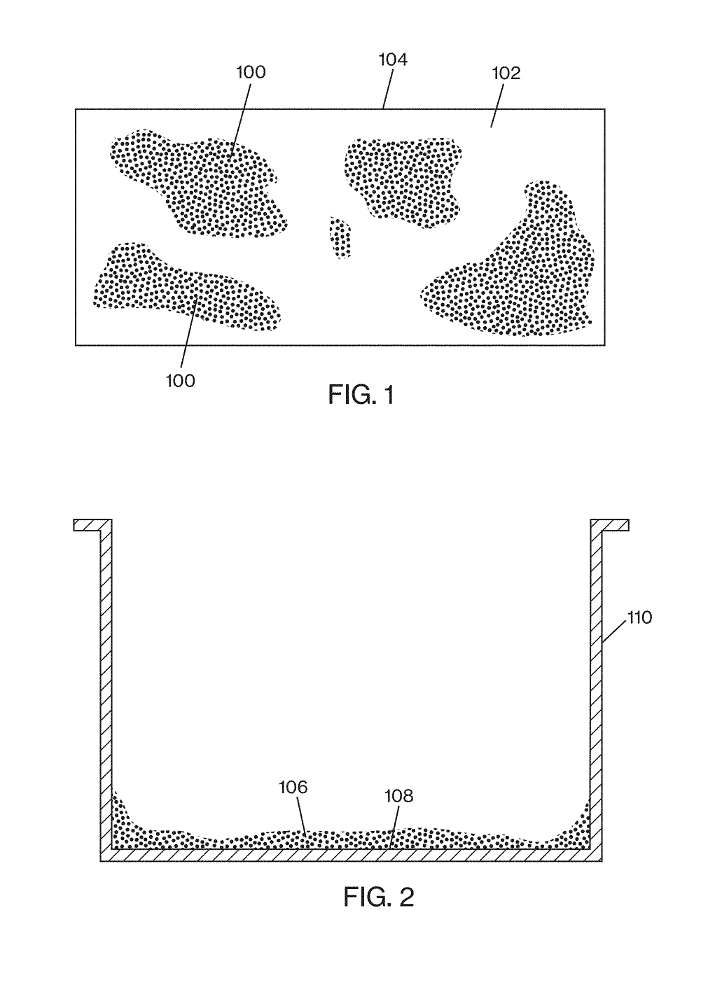

FIG. 1 depicts ion-exchange process residue 100 on a surface 102 of an ion-exchangeable substrate 104. In one or more embodiments, the ion-exchangeable substrate 104 may be a glass or glass-ceramic substrate or article containing lithium. FIG. 2 depicts ion-exchange process residue 106 on a surface 108 of an ion-exchange tank 110. The ion-exchange process residue 106 is what remains on the surface 108 of the ion-exchange process after the salt bath has been drained from the ion-exchange tank 100. In one or more embodiments, both the ion-exchange process residue 100 and the ion-exchange process residue 106 contain at least one insoluble lithium phosphate compound produced during an ion-exchange process, where the term “insoluble” is as previously defined. In some embodiments, both the ion-exchange process residue 100 and the ion-exchange process residue 106 contain at least one insoluble lithium phosphate compound selected from Li₃PO₄, Li₂NaPO₄, and LiNa₂PO₄, where the term “insoluble” is as previously defined. For example, the solubility of Li₃PO₄ is 0.039 g per 100 g of water at room temperature (i.e., about 20° C.).

In one or more embodiments, a method for removing the ion-exchange process residue 100 from the surface 102 includes converting the insoluble lithium phosphate compounds in the ion-exchange process residue 100 into soluble lithium hydrogen phosphate compounds. In some embodiments, the insoluble lithium phosphate compounds are converted to dilithium hydrogen phosphate (Li₂HPO₄) salt and/or lithium dihydrogen phosphate (LiH₂PO₄) salt.

In one or more embodiments, the method includes preparing a cleaning aqueous solution having a pH less than 5. In other embodiments, the method includes preparing a cleaning aqueous solution having a pH less than 4. In yet other embodiments, the method includes preparing a cleaning aqueous solution having a pH less than 3.0. In one or more embodiments, the cleaning aqueous solution includes an acid or a mixture of acids. In some embodiments, the acids in the cleaning aqueous solution may be selected from nitric acid, hydrochloric acid, phosphoric acid, sulfuric acid, citric acid, acetic acid, tartaric acid, ascorbic acid, and other such weak acids. In one or more embodiments, the concentration of the acid or acid mixture in the cleaning aqueous solution may be in a range from 0.1 wt % to 10 wt %. The cleaning aqueous solution as described above is able to react with an insoluble lithium phosphate compound at room temperature (i.e., about 20° C.) or elevated temperature from 20° C. to 100° C. to produce a soluble lithium hydrogen phosphate compound and then dissolve the soluble lithium hydrogen phosphate compound.

In one or more embodiments, the method includes soaking the surface 102 with the ion-exchange process residue 100 in the cleaning aqueous solution. In one example, the soaking process may involve spraying the cleaning aqueous solution on the surface 102 to completely cover the ion-exchange process residue 100 on the surface 102 with the cleaning aqueous solution. In another example, the soaking process may involve immersing the surface 102 in the cleaning aqueous solution. In yet another example, water and acid (or acid mixture) may be separately applied to the surface 102 to form the cleaning aqueous solution on the surface 102 and soak the surface 102 with the cleaning aqueous solution.

Upon soaking the surface 102 with the cleaning aqueous solution, the acid in the cleaning aqueous solution will dissociate and produce protons (H⁺). The lithium phosphates in the ion-exchange process residue 100 will react with the protons (H⁺) to form hydrogen phosphate ions ((HPO₄)²³¹, (H₂PO₄)⁻) and lithium hydrogen phosphate salts (e.g., Li₂HPO₄ and/or LiH₂PO₄). These new lithium hydrogen phosphate salts have a much better solubility compared to lithium phosphate salts and will readily dissolve in water. For example, the solubility of LiH₂PO₄ is 126 g per 100 g of water at room temperature (in comparison, the solubility of Li₃PO₄ is 0.039 g per 100 g of water at room temperature).

Examples of chemical equations of protons reacting with lithium phosphate salts are given below. In the first reaction equation, solid lithium phosphate reacts with phosphoric acid to produce aqueous lithium hydrogen phosphate. In the second reaction equation, aqueous lithium hydrogen phosphate reacts with phosphoric acid to produce aqueous lithium dihydrogen phosphate.

2Li₃PO₄(s)+H₃PO₄(aq.)→3Li₂HPO₄(aq.) (1)

Li₂HPO₄(aq.)+H₃PO₄(aq.)→2LiH₂PO₄(aq.) (2)

In general, proton (or hydronium ion) can react with lithium phosphate according to the reaction equations (3) and (4) given below.

Li₃PO₄(s)+H⁺(aq.)→3Li⁺(aq.)+(HPO₄)²⁻(aq.) (3)

Li₃PO₄(s)+2H⁺(aq.)→3Li⁺(aq.)+(H₂PO₄)⁻(aq.) (4)

The method includes soaking the surface 102 in the cleaning aqueous solution for a time period sufficient to convert the lithium phosphate(s) in the residue 100 to soluble lithium hydrogen phosphates and for the soluble lithium hydrogen phosphates to dissolve in the cleaning aqueous solution. For a relatively thin layer of residue, e.g., thickness in a range from 1 to 100 microns, the soaking time may be in a range from 1 to 10 minutes, and the surface 102 and cleaning aqueous solution may be maintained at room temperature (i.e., about 20° C.) during the soaking. For a thicker layer of residue, a longer soaking time may be needed and/or the soaking may occur at a temperature above room temperature from 20° C. to 100° C. After the lithium phosphates have been completely converted to soluble lithium hydrogen phosphates and the soluble lithium hydrogen phosphates have dissolved in the cleaning aqueous solution, the surface 102 is rinsed with deionized water. According to one or more embodiments, after the rinsing, the surface 102 will be substantially free of lithium phosphates. The surface 102 can be allowed to dry in air after the rinsing.

The ion-exchange process residue 106 on the surface 108 of the ion-exchange tank 110 (FIG. 2) can be removed in the same manner described above. That is, the surface 108 may be soaked in cleaning aqueous solution, as described above, to convert lithium phosphates in the ion-exchange process residue 106 to soluble lithium hydrogen phosphates. Then, the surface 108 can be rinsed with deionized water. The surface 108 may be allowed to dry prior to loading another salt bath into the ion-exchange tank 100.

The thickness of the ion-exchange process residue 106 on the tank surface 108 (FIG. 2) will typically be greater than the thickness of the ion-exchange process residue 100 on the substrate surface 102 (FIG. 1) because the residue 106 on the tank surface 108 would have built up over multiple ion-exchange process runs. Further, the ion-exchange process residue 106 on the tank surface 108 will generally cover a larger area than the residue 100 on the substrate surface 102. This means that the soaking time for the residue 106, i.e., to convert the lithium phosphates in the residue 106 to soluble lithium hydrogen phosphates and dissolve the soluble lithium hydrogen phosphates, will be much longer compared to the soaking time for the residue 100. In some embodiments, it may take a few hours to completely convert the lithium phosphates in the residue 106 to soluble lithium hydrogen phosphates. The conversion may be facilitated by heating the surface 108 and/or cleaning aqueous solution such that the soaking occurs at an elevated temperature. In one example, the surface 108 and/or cleaning aqueous solution are heated to a temperature in a range from 40° C. to 100° C. In another example, the surface 108 and/or cleaning aqueous solution are heated to a temperature in a range from 40° C. to 80° C. In general, for safety reasons, the temperature should be below the boiling point of the solution or below the point at which acidic vapors can be generated from the solution.

### Example 1—Cleaning Glass Surface Residue with Acetic Acid

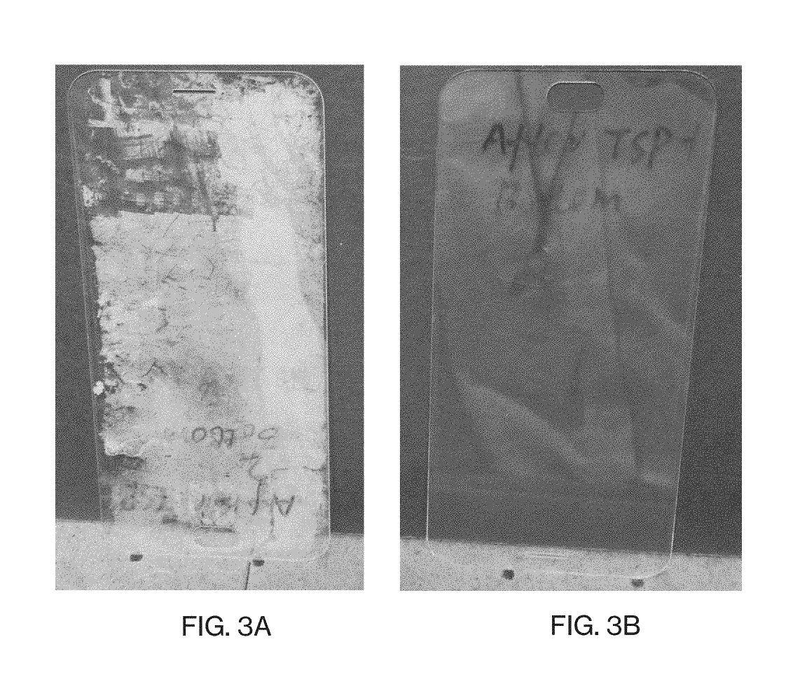

A glass substrate containing lithium was subjected to an ion-exchange process in a molten salt bath to which sodium phosphate (Na₃PO₄) was added to control lithium poisoning of the salt bath. An XRD spectrum of the ion-exchange process residue on a surface of the glass substrate after the ion-exchange process revealed that the residue was mostly lithium phosphate and lithium sodium phosphate. The glass substrate was soaked in 1 wt % acetic acid solution at 25° C. for 3 minutes. After the soaking, the surface of the glass substrate was gently and briefly rinsed in deionized water. The glass substrate was then dried in air. After the drying, no chemical residue (or haze) was observed on the surface of the glass substrate. FIG. 3A shows the glass substrate before treatment in the acetic acid solution, where the glass substrate is not free of haze. FIG. 3B shows the glass substrate after treatment in the acetic acid solution, where the glass substrate is substantially free of haze.

### Example 2—Dissolving Lithium Phosphate Precipitate with Phosphoric Acid

Lithium phosphate (Li₃PO₄) was prepared in 100 mL of aqueous solution by mixing 0.1 mol of LiNO₃ and 0.034 mol Na₃PO₄ together. The insoluble Li₃PO₄ formed immediately and precipitated to the bottom of the beaker within 1 minute. About 0.1 mol of H₃PO₄ was added to the solution (pH of the solution was about 2), and the Li₃PO₄ precipitate was completely dissolved within 1 minute. This example illustrates that an aqueous solution containing phosphoric acid is effective in converting insoluble Li₃PO₄ to a soluble salt and can be used to clean a surface having ion-exchange process residue containing lithium phosphate.

### Example 3—Dissolving Lithium Phosphate Precipitate by Acetic Acid

Lithium phosphate (Li₃PO₄) was prepared in 80 mL of aqueous solution by mixing 0.12 mol of LiNO₃ and 0.04 mol of Na₃PO₄ together. The insoluble Li₃PO₄ formed immediately and precipitated to the bottom of the beaker within 1 minute. About 0.04 mol of acetic acid was added to the solution, and the Li₃PO₄ precipitate was completely dissolved within 1 minute. This example illustrates that an aqueous solution containing acetic acid is effective in converting Li₃PO₄ to a soluble and can be used to clean a surface having ion-exchange process residue containing lithium phosphate.

### Example 4—Dissolving Residue on Ion-Exchange Tank Surface

2.1 g of ion-exchange tank sludge was mixed in 30 mL of deionized water. The sludge did not dissolve in water even after being heated to 80° C. About 0.12 mol of acetic acid or tartaric acid was added to the solution containing the sludge. At 80° C., the precipitate dissolved in the aqueous solution with assistance of the acid. This example shows that ion-exchange process residue on a surface of an ion-exchange tank can be effectively removed from the surface using an aqueous solution containing acetic acid or tartaric acid.

The method of removing ion-exchange process residue from a surface described above may be incorporated into methods for preparing strengthened glass or glass-ceramic.

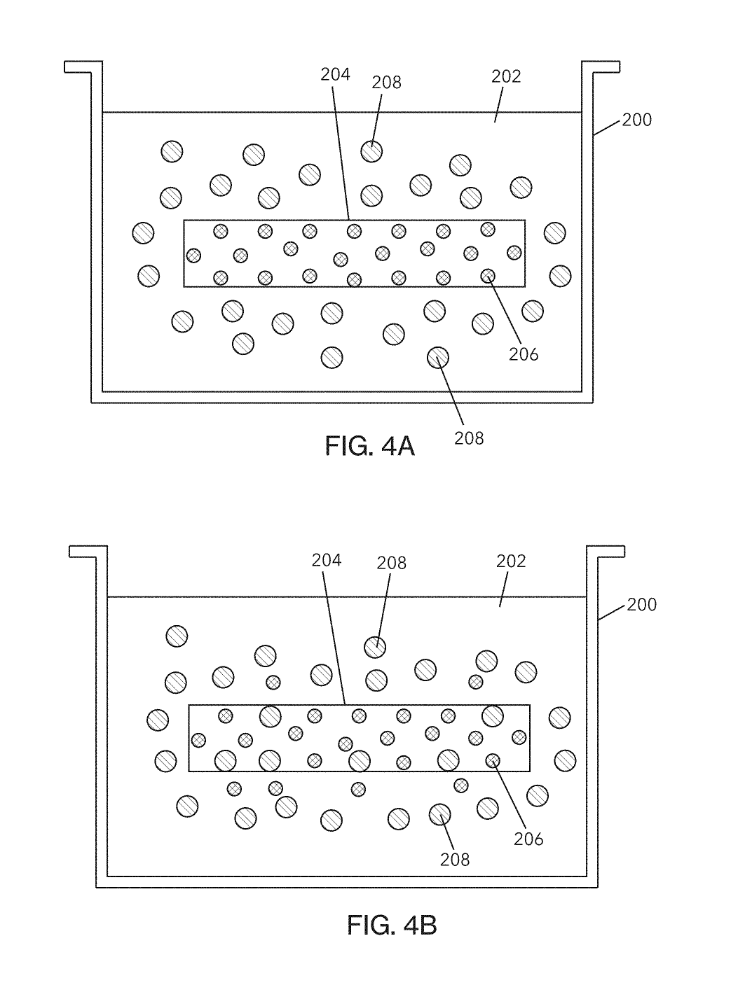

FIG. 4A shows an ion-exchange tank 200 containing a salt bath 202. An ion-exchangeable substrate 204 is in contact with the salt bath 202. In this example, the ion-exchangeable substrate 204 is immersed in the salt bath and all of the surfaces of the substrate 204 are in contact with the salt bath 202. In other examples, only one or some of the surfaces of the substrate 204 may be in contact with the salt bath 102. In one or more embodiments, the ion-exchangeable substrate 204 is a lithium-containing glass material. In one or more embodiments, the ion-exchangeable substrate 204 contains lithium cations 206 that are exchanged with larger alkali-metal ions 208 in the salt bath 202 during an ion-exchange process.

In one or more embodiments, the ion-exchangeable substrate 204 is formed from a composition comprising Li₂O as the source of the lithium cations 106. In some embodiments, the lithium-containing glass material 204 may include 2.0 mol % to 25 mol % Li₂O. In other embodiments, the lithium-containing glass material 204 may include 2.0 mol % to 10 mol % Li₂O or 2.5 mol % to 10 mol % Li₂O. In yet other embodiments, the lithium-containing glass material 204 may include 5 mol % to 15 mol % Li₂O or 5 mol % to 10 mol % Li₂O or 5 mol % to 8 mol % Li₂O.

In one or more embodiments, the ion-exchangeable substrate 204 comprises an alkali aluminosilicate glass or an alkali aluminoborosilicate glass. In a first example, the ion-exchangeable substrate 204 may be formed from a composition including 60 to 75 mol % SiO₂, 0 to 3 mol % B₂O₃, 10 to 25 mol % Al₂O₃, 2 to 15 mol % Li₂O, 0 to 12 mol % Na₂O, 0 to 5 mol % MgO, 0 to 5 mol % ZnO, 0 to 5 mol % SnO₂, and 0 to 10 mol % P₂O₅. In a second example, the ion-exchangeable substrate may be formed from a composition including 50 to 80 mol % SiO₂, 0 to 5 mol % B₂O₃, 5 to 30 mol % Al₂O₃, 2 to 25 mol % Li₂O, 0 to 15 mol % Na₂O, 0 to 5 mol % MgO, 0 to 5 mol % ZnO, 0 to 1 mol % SnO₂, and 0 to 5 mol % P₂O₅. In some examples, the ion-exchangeable substrate 204 may be formed from a composition as described in the first and second examples without one or more of B₂O₃, P₂O₅, MgO, ZnO, and SnO₂. It should be understood that these glass compositions are illustrative and that other lithium-containing glass compositions for use with the methods described herein are contemplated and possible.

The salt bath 202 includes one or more sources of alkali-metal cations 208. In one or more embodiments, the alkali-metal cations 208 in the salt bath 202 are larger than the lithium cations in the ion-exchange substrate 204. In some embodiments, the salt bath 202 includes at least one of KNO₃ and NaNO₃ as the one or more sources of alkali-metal cations 208. In a first example, the salt bath 202 may comprise 40 mol % to 95 mol % KNO₃ and 5 mol % to 60 mol % NaNO₃. In a second example, the salt bath 202 may comprise 45 mol % to 50 mol % KNO₃ and 50 mol % to 55 mol % NaNO₃. In a third example, the salt bath 202 may comprise 75 mol % to 95 mol % KNO₃ and 5 mol % to 25 mol % NaNO₃. In a fourth example, the salt bath 202 may comprise 45 mol % to 67 mol % KNO₃ and 33 mol % to 55 mol % NaNO₃.

While the ion-exchangeable substrate 204 is in contact with the salt bath 202, exchange of ions may occur near the surface of the ion-exchangeable substrate 204. This is illustrated, for example, in FIG. 4B, where lithium cations 206 have diffused from the ion-exchangeable substrate 204 into the salt bath 202 and larger alkali-metal cations 208 have diffused from the salt bath 202 into the ion-exchangeable substrate 204. Besides lithium cations, other alkali-metal cations, such as sodium cations, may also diffuse from the ion-exchangeable substrate 204 into the salt bath 202, and the sites left by these other alkali-metal cations may be occupied by larger alkali-metal cations from the salt bath 202. In general, it will be easier to exchange smaller lithium cations than larger alkali-metal cations within the glass material structure.

The ion exchange between the salt bath 202 and the ion-exchangeable substrate 204 may be promoted by heating the salt bath 202 to an elevated temperature. The salt bath 202 may be in molten form at the elevated temperature. The temperature of the salt bath 202 may be controlled to obtain the desired compressive stress and depth of layer in the glass material. In some embodiments, the salt bath 202 may be heated to a temperature in a range from 360° C. to 430° C.

In some embodiments, one or more phosphate salts are added to the salt bath 202 to precipitate out excess lithium cations to form solid lithium phosphates. The phosphate salt may be added to the salt bath 202 in an amount to reduce the lithium cation concentration in the salt bath 202 to a level at which poisoning of the salt bath 202 is prevented. In some embodiments, the salt bath 202 may be considered as not poisoned if the concentration of lithium cations dissolved in the salt bath 202 is not greater than 2 wt %. The phosphate salt may be added to the salt bath 202 before the ion exchange process starts and/or during the ion exchange process. The phosphate salt may be added to the salt bath 202 when a certain lithium cation concentration has been exceeded in the salt bath 202 or when a certain compressive stress has been attained in the ion-exchangeable substrate 204. Examples of phosphates that may be added to the salt bath include, but are not limited to, Na₃PO₄, K₃PO₄, Na₂HPO₄, K₂HPO₄, Na₅P₃O₁₀, Na₂H₂P₂O₇, Na₄P₂O₇, K₄P₂O₇, Na₃P₃O₉, and K₃P₃O₉. In some embodiments, Na₃PO₄ and/or K₃PO₄ are added to the salt bath.

When the ion-exchangeable substrate 204 is removed from the salt bath, there will be residue on the surface(s) of the ion-exchangeable substrate 204. In one or more embodiments, this residue will contain solid lithium phosphate. Similarly, when the salt bath is drained from the ion-exchange tank 200 after the ion-exchange process, there will be residue on the surface(s) of the ion-exchange tank 200. In one or more embodiments, this residue will contain solid lithium phosphate. In one or more embodiments, to remove the residues containing lithium phosphate from the surface(s) of the ion-exchangeable substrate 204 or the surface(s) of the ion-exchange tank 200, the surfaces can be soaked in a cleaning aqueous solution, having characteristics as described previously. The soaking should be for a sufficient period to allow the solid lithium phosphate in the residue to be converted to soluble lithium hydrogen phosphate and for the soluble lithium hydrogen phosphate to dissolve in the cleaning aqueous solution. The soaking may occur at room temperature or elevated temperature between 20° C. and 100° C., as previously described. After the soaking, the surfaces can be rinsed with water or deionized water and allowed to dry.

While the invention has been described with respect to a limited number of embodiments, those skilled in the art of, having benefit of this disclosure, will appreciate that other embodiments can be devised which do not depart from the scope of the invention as disclosed herein. Accordingly, the scope of the invention should be limited only by the accompanying claims.

1. A method of removing residue containing one or more insoluble lithium phosphate compounds from a surface, comprising:
soaking the surface in a cleaning aqueous solution having a pH less than 5 for a select time period, whereby at least one insoluble lithium phosphate compound in the residue is converted into soluble lithium hydrogen phosphate and the soluble lithium hydrogen phosphate is dissolved in the cleaning aqueous solution; and
rinsing the surface.

2. The method of claim 1, wherein the cleaning aqueous solution comprises an acid or acid mixture selected from nitric acid, hydrochloric acid, phosphoric acid, sulfuric acid, citric acid, acetic acid, tartaric acid, ascorbic acid, and mixtures thereof.

3. The method of claim 1, wherein the cleaning aqueous solution comprises an acid or acid mixture, and wherein the cleaning aqueous solution has an acid concentration in a range of 0.1 wt % to 10 wt %.

4. The method of claim 1, wherein the surface is a surface of a lithium-containing glass material treated in a salt bath comprising a phosphate salt and at least one source of alkali metal cations larger than lithium cations.

5. The method of claim 4, further comprising maintaining the surface and the cleaning aqueous solution at a temperature from 20° C. to 100° C. during the soaking.

6. The method of claim 4, wherein the select time period is in a range from 1 minute to 10 minutes.

7. The method of claim 1, wherein the surface is a surface of an ion-exchange tank containing a salt bath during treatment of a lithium-containing glass material in the salt bath, the salt bath comprising a phosphate salt and at least one source of alkali metal cations larger than lithium cations.

8. The method of claim 7, further comprising maintaining a temperature of at least one of the surface and the cleaning aqueous solution at a temperature from 20° C. to 100° C. during at least a portion of the soaking.

9. The method of claim 7, further comprising maintaining a temperature of at least one of the surface and the cleaning aqueous solution in a range from 40° C. to 100° C. during at least a portion of the soaking.

10. The method of claim 7, wherein the select time period is greater than 1 hour.

11. The method of claim 1, wherein the at least one insoluble lithium phosphate compound is Li₃PO₄, Li₂NaPO₄, or LiNa₂PO₄.

12. The method of claim 1, wherein the soluble lithium hydrogen phosphate comprises at least one of Li₂HPO₄ and LiH₂PO₄.

13. A method of preparing strengthened glass or glass-ceramic, comprising:
heating a salt bath comprising a phosphate salt and at least one source of alkali metal cations to a temperature greater than 360° C.;
contacting at least a portion of an ion-exchangeable substrate comprising lithium cations with the salt bath, whereby at least a portion of the lithium cations diffuse from the ion-exchangeable substrate into the salt bath and are dissolved in the salt bath;
selectively precipitating the dissolved lithium cations from the salt bath to form at least one insoluble lithium phosphate compound, wherein a portion of the at least one insoluble lithium phosphate compound is deposited on a surface of the ion-exchangeable substrate;
removing the ion-exchangeable substrate from the salt bath and soaking the surface in a cleaning aqueous solution having a pH less than 5 for a select time period, whereby the at least one insoluble lithium phosphate compound on the surface is converted into soluble lithium hydrogen phosphate and the soluble lithium hydrogen phosphate is dissolved in the cleaning aqueous solution; and
rinsing the surface.

14. The method of claim 13, wherein the cleaning aqueous solution comprises an acid or acid mixture selected from nitric acid, hydrochloric acid, phosphoric acid, sulfuric acid, citric acid, acetic acid, tartaric acid, ascorbic acid, and mixtures thereof.

15. The method of claim 13, wherein the cleaning aqueous solution comprises one or more acids, and wherein the cleaning aqueous solution has an acid concentration in a range of 0.1 wt % to 10 wt %.

16. The method of claim 13, wherein the soaking occurs at a temperature from 20° C. to 100° C. and the select time period is less than 10 minutes.

17. The method of claim 13, wherein the phosphate salt is added to the salt bath prior to contacting the at least a portion of the ion-exchangeable substrate with the salt bath.

18. The method of claim 13, wherein the phosphate salt comprises at least one of Na₃PO₄, K₃PO₄, Na₂HPO₄, K₂HPO₄, NasP₃O₁₀, Na₂H₂P₂O₇, Na₄P₂O₇, K₄P₂O₇, Na₃P₃O₉, and K₃P₃O₉.

19. The method of claim 13, wherein the at least one source of alkali metal cations comprises at least one of KNO₃ and NaNO₃.

20. The method of claim 13, wherein the ion-exchangeable substrate comprises an alkali aluminosilicate glass or an alkali aluminoborosilicate glass.
